(19) United States
(12) Patent Application Publication
(10) Pub. No.: US 2019/0152265 A1
(43) Pub. Date: May 23, 2019

(54) PNEUMATIC TIRE

(71) Applicant: Toyo Tire & Rubber Co., Ltd., Itami-shi (JP)

(72) Inventor: Seiji Yokomakura, Itami-shi (JP)

(73) Assignee: Toyo Tire & Rubber Co., Ltd., Itami-shi (JP)

(21) Appl. No.: 16/177,534

(22) Filed: Nov. 1, 2018

(30) Foreign Application Priority Data
Nov. 17, 2017 (JP) 2017-222135

(51) Int. Cl. B60C 11/01; B60C 11/13

(52) U.S. Cl. CPC B60C 11/01; B60C 2011/013; B60C 11/1353

(57) ABSTRACT

A pneumatic tire includes: a tread; a sidewall; a buttress portion provided between the tread and the sidewall; a recessed groove provided along a tire circumferential direction in the buttress portion; and plural small holes provided at spaced intervals along the tire circumferential direction in a groove bottom of the recessed groove.

### BACKGROUND OF THE INVENTION

### 1. Field of the Invention

The present invention relates to a pneumatic tire.

### 2. Description of the Related Art

In general, a pneumatic tire has a high ground contact pressure in a portion near a ground contact end of a tread during travel. Thus, there is a case where the pneumatic tire is worn unevenly such that an amount of wear in the portion near the ground contact end is larger than the rest of the portions. As disclosed in JP 2003-39917 A and JP 2008-296799 A, as a method of suppressing such uneven wear, a recessed groove that extends in a tire circumferential direction is provided in a buttress portion provided between the tread and a sidewall. In this method, the ground contact pressure is lowered by lowering rigidity of the portion near the ground contact end of the tread, and the uneven wear can thereby be suppressed.

The ground contact pressure in the portion near the ground contact end tends to be gradually lowered from an outer side to an inner side in a tire width direction. In addition, a worn shape of the tread differs by a shape of a groove, a sipe, or the like provided in the tread.

While the rigidity of the portion near the ground contact end can be lowered in the tire disclosed in each of the above literature, it is difficult to control a lowering amount of the rigidity in the tire width direction. Consequently, the ground contact pressure cannot be uniformized in accordance with the shape of the tread, and the uneven wear cannot sufficiently be suppressed.

More specifically, in the tire disclosed in each of the above literature, the recessed groove in the buttress portion is set such that groove width in a cross section thereof is reduced toward a deep side in a depth direction. In this way, rigidity of a tread rubber portion that is located on an outer side of the recessed groove in a tire radial direction can vary in the tire width direction. However, when the tire contacts the ground, the entire tread rubber portion, which is located on the outer side of the recessed groove in the tire radial direction, is bent with a bottom of the recessed groove being an origin. Consequently, it is difficult to control the rigidity of the tread rubber portion in the tire width direction, and the uneven wear of the portion near the ground contact end cannot sufficiently be suppressed.

### SUMMARY OF THE INVENTION

In view of the above, the present invention has a purpose of providing a pneumatic tire that includes a recessed groove in a buttress portion and that can suppress uneven wear of a portion near a ground contact end of a tread.

A pneumatic tire according to an embodiment includes: a tread; a sidewall; a buttress portion provided between the tread and the sidewall; a recessed groove provided along a tire circumferential direction in the buttress portion; and plural small holes provided at spaced intervals along the tire circumferential direction in a groove bottom of the recessed groove.

### BRIEF DESCRIPTION OF THE DRAWINGS

FIG. 1 is a perspective view of a half cross section of a pneumatic tire according to a first embodiment of the present invention.

FIG. 2 is a side view of primary sections of the pneumatic tire in FIG. 1.

FIG. 3 is a cross-sectional view of the primary sections of the pneumatic tire in FIG. 1.

FIG. 4 is another cross-sectional view of the primary sections of the pneumatic tire in FIG. 1.

FIG. 5 is a cross-sectional view of primary sections of a pneumatic tire according to a modified embodiment of the present invention.

FIG. 6 is a cross-sectional view of primary sections of a pneumatic tire according to another modified embodiment of the present invention.

### DESCRIPTION OF THE PREFERRED EMBODIMENTS

A description will hereinafter be made on an embodiment of the present invention with reference to the drawings.

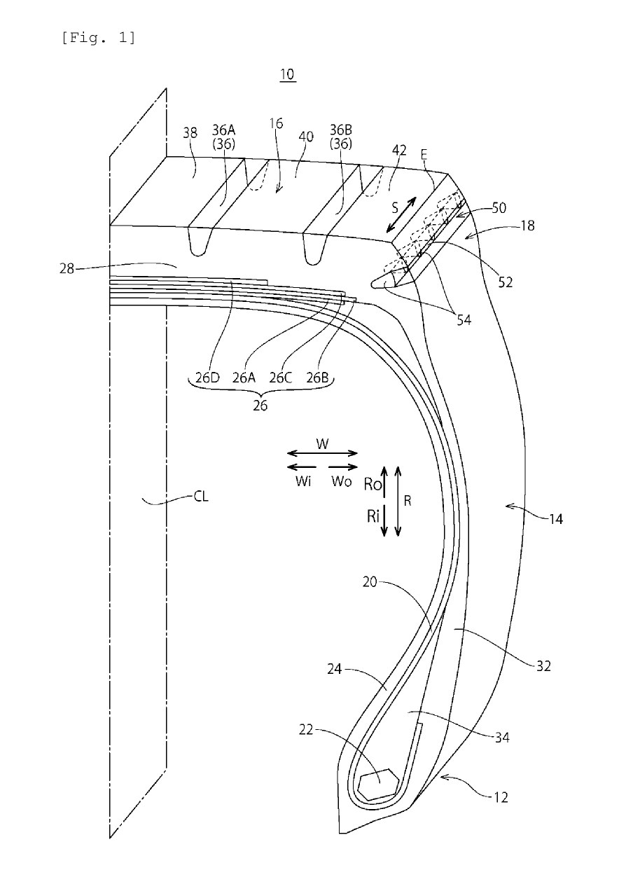

FIG. 1 is a perspective view of a right-half cross section of a pneumatic tire 10 according to this embodiment, and the right-half cross section is taken along a meridian cross section that includes a tire axis. Since the pneumatic tire 10 is a bilaterally symmetrical tire, a left-half portion thereof is not illustrated.

The pneumatic tire 10 in FIG. 1 includes: a right and left pair of beads 12; a right and left pair of sidewalls 14, each of which extends radially outward from the bead 12; a tread 16 that constitutes a tread surface; and a right and left pair of buttress portions 18, each of which is arranged on an inner side of the tread 16 in a tire radial direction. Here, each of the buttress portions 18 is a boundary region between the tread 16 and the sidewall 14 and is provided to connect the tread 16 and the sidewall 14.

The pneumatic tire 10 includes a carcass ply 20 that is stretched toroidally between the pair of the beads 12. A ring-shaped bead core 22 is embedded in each of the paired beads 12.

The carcass ply 20 is stretched from the tread 16 to the bead 12 through the buttress portion 18 and the sidewall 14, and is locked by the bead core 22 in the bead 12. In this way, the carcass ply 20 reinforces each of the above portions 12, 14, 16, 18. In this example, each end of the carcass ply 20 is folded around the bead core 22 from an inner side to an outer side thereof in a tire width direction, and is thereby locked. An inner liner 24 that keeps an air pressure is disposed on an inner side of the carcass ply 20.

The carcass ply 20 includes at least a single ply in which organic fiber cords are arranged at a specified angle (for example, 70° to 90°) with respect to a tire circumferential direction S and are covered with topping rubber. In this example, the carcass ply 20 is configured to include the single ply. As the cords that constitute the carcass ply 20, the organic fiber cords such as polyester fiber cords, rayon fiber cords, aramid fiber cords, or nylon fiber cords are preferably used.

In each of the sidewalls 14, sidewall rubber 32 is provided on an outer side of the carcass ply 20 (that is, on a tire outer surface side). In addition, in each of the beads 12, a bead filler 34 is disposed on an outer circumferential side of the bead core 22. The bead filler 34 is made from a hard rubber material and extends outward in a tire radial direction so as to form a wedge.

In the tread 16, a belt 26 is disposed on an outer circumferential side of the carcass ply 20. That is, the belt 26 is provided between the carcass ply 20 and tread rubber 28 in the tread 16. The belt 26 includes plural crossed belt plies in which belt cords are tilted at a specified angle (for example, 10° to 35°) with respect to the tire circumferential direction S. As the belt cords, steel cords or the organic fiber cords with a high tensile force are used.

In this example, the belt 26 has a four-layer structure that includes: a first belt 26A that is located on an innermost side Ri in the tire radial direction; and a second belt 26B, a third belt 26C, and a fourth belt 26D that are sequentially stacked on an outer circumferential side of the first belt 26A. Of the belts, the second belt 26B is a maximum width belt having the greatest width.

Four main grooves 36, each of which extends along the tire circumferential direction S, are provided on a surface of the tread 16. More specifically, the main grooves 36 are configured to include: a pair of main center grooves 36A disposed on both sides of a tire equatorial plane CL; and a pair of main shoulder grooves 36B provided on outer sides Wo of the paired main center grooves 36A in the tire width direction. The outer side Wo in the tire width direction is a side that is away from the tire equatorial plane CL in a tire width direction W.

In the tread 16, the above four main grooves 36 form a center land 38 between the two main center grooves 36A, an intermediate land 40 between each of the main center grooves 36A and each of the main shoulder grooves 36B, and a shoulder land 42 on the outer side Wo of each of the two main shoulder grooves 36B in the tire width direction.

In this example, each of the center land 38, the intermediate lands 40, and the shoulder lands 42 is a rib that continues in the tire circumferential direction S. Note that each of the center land 38, the intermediate lands 40, and the shoulder lands 42 may be a row of blocks that are divided in the tire circumferential direction S by lateral grooves.

In each of the shoulder lands 42, an outer end of the tread surface in the tire width direction is a tread ground contact end E. The buttress portion 18, which extends inward in the tire radial direction and constitutes an upper portion of a tire lateral surface, is connected to the tread ground contact end E.

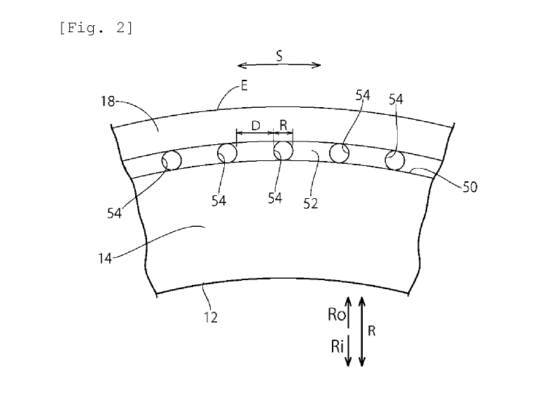

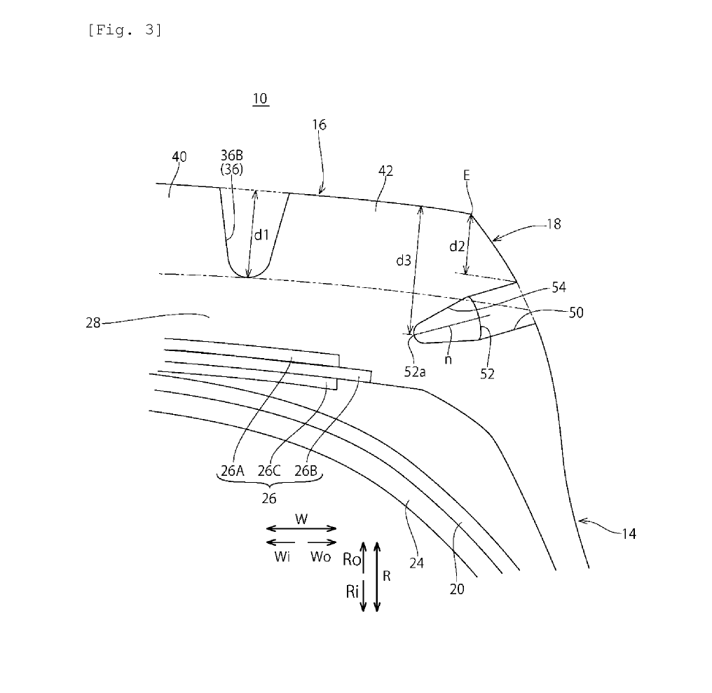

As illustrated in FIG. 1 to FIG. 4, each of the buttress portions 18 is provided with a recessed groove 50 and small holes 54.

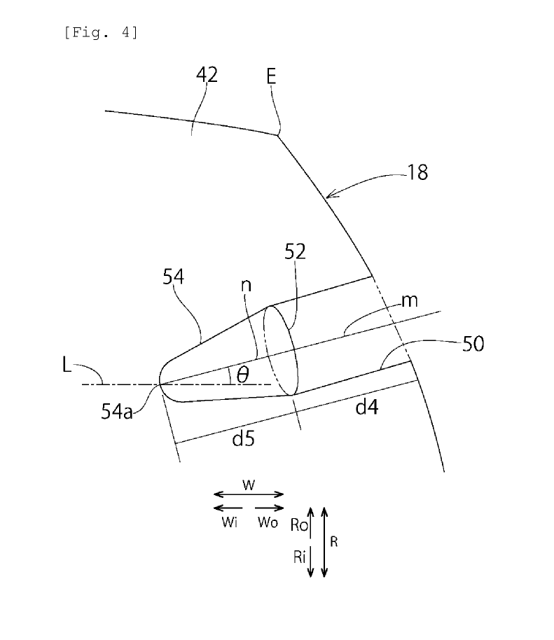

In detail, the recessed groove 50 is a continuous annular recess that is provided for an entire circumference in the tire circumferential direction S. In this embodiment, the recessed groove 50 is recessed in a tilted direction m to a direction L that is perpendicular to the tire equatorial plane CL, so as to be recessed inward Ri in the tire radial direction toward a deep side in a depth direction (see FIG. 4). In addition, the recessed groove 50 has substantially constant groove width from an opening of the buttress portion 18 to a groove bottom 52.

The groove bottom 52 of each of the recessed grooves 50 has a substantially perpendicular surface to the depth direction m. This groove bottom 52 is provided with the plural small holes 54 at spaced intervals along the tire circumferential direction S.

Each of the small holes 54 is a recess that is recessed in the same direction n as the depth direction m of the recessed groove 50. That is, the depth direction m of the recessed groove 50 and the depth direction n of the small holes 54 are parallel to each other. Each of the small holes 54 has a circular cross-sectional shape. In each of the small holes 54, a diameter R of a portion that is opened to the groove bottom 52 of the recessed groove 50 is equal to the width of the recessed groove 50 (length of the recessed groove 50 in the tire radial direction). Each of the small holes 54 is tapered such that a cross-sectional area thereof is reduced toward a deep side in the depth direction n.

Here, the depth direction m of the recessed grooves 50 and the depth direction n of the small holes 54 are preferred that a tilt angle θ thereof with respect to the perpendicular direction L to the tire equatorial plane CL is equal to or smaller than ±30°.

A distance d2 from the tread surface of the shoulder land 42 to an outer end of the recessed groove 50 in the tire radial direction (that is, an outer side in the tire radial direction of an opened end of the recessed groove 50 that is opened to the buttress portion 18) can be set to be equal to or longer than 70% of groove depth d1 of the main shoulder groove 36B and be equal to or shorter than 100% thereof. A distance d3 from the tread surface of the shoulder land 42 to a bottom 54a of each of the small holes 54 can be set to be longer than the groove depth d1 of the main shoulder groove 36B. In addition, the recessed grooves 50 and the small holes 54 can be arranged outward Ro in the tire radial direction from the belt 26.

An interval D between two each of the small holes 54 in the tire circumferential direction S can be set to be equal to or longer than 200% of the diameter R of each of the small holes 54 and be equal to or shorter than 400% thereof. Depth d5 of each of the small holes 54 can be set to be equal to or greater than 20% of depth d4 of the recessed groove 50 and equal to or less than 100% thereof.

Note that the above dimensions in the present specification are those in a legitimate unloaded state of the pneumatic tire that is attached to a legitimate rim and has a legitimate internal pressure unless otherwise noted. In addition, in the present specification, the tread ground contact end is an end of the tread surface, which contacts a road surface, in the tire width direction in a legitimate loaded state of the pneumatic tire that is assembled to the legitimate rim and has the legitimate internal pressure. In the legitimate loaded state, the pneumatic tire is placed perpendicularly on the flat road surface and is applied with a legitimate load.

In a system of standards including a standard with which the tire complies, the legitimate rim is a rim that is defined per tire in the standard. For example, the legitimate rim is specified as the “standard rim” in JATMA, the “Design Rim” in TRA, and the “Measuring Rim” in ETRTO. In the system of the standards including the standard with which the tire complies, the legitimate internal pressure is the air pressure that is defined in the standard set per tire, and is specified as the “maximum inflation pressure” in JATMA, a maximum value set in the table “TIRE LOAD LIMITS AT VARIOUS COLD INFLATION PRESSURES” in TRA, and the “INFLATION PRESSURE” in ETRTO. In the case where the tire is for a passenger automobile, the legitimate internal pressure is set at 180 kPa. In the system of the standards including the standard with which the tire complies, the legitimate load is a load that is defined in the standard set per tire, and is specified as the “maximum load capacity” in JATMA, the maximum value set in the above table in TRA, and the “LOAD CAPACITY” in ETRTO. In the case where the tire is for the passenger automobile, the legitimate load is a load that corresponds to 88% of the above load.

The pneumatic tire 10 of this embodiment as described so far includes: the recessed grooves 50, each of which is provided along the tire circumferential direction S in the buttress portion 18; and the plural small holes 54 that are provided at the spaced intervals along the tire circumferential direction S in the groove bottom 52 of each of the recessed grooves 50. Thus, rigidity of the pneumatic tire 10 can significantly be lowered at positions corresponding to the recessed grooves 50, and the rigidity thereof can gradually be lowered at positions corresponding to the small holes 54. Therefore, a rigidity lowering amount in a portion near the ground contact end E of each of the shoulder lands 42 can gradually be lowered from the outer side Wo to an inner side Wi in the tire width direction, and uneven wear of the portion near the ground contact end E can effectively be suppressed.

In this embodiment, heat generated during travel can efficiently be dissipated from the recessed grooves 50 and the small holes 54 provided in the buttress portions 18. Thus, it is possible to improve durability and the like of the pneumatic tire 10 during the high-speed travel.

Each of the small holes 54, which are provided in the groove bottoms 52 of the recessed grooves 50, is tapered such that the cross-sectional area thereof is reduced toward the deep side in the depth direction n. Thus, at the position corresponding to each of the small holes 54, the rigidity can gradually be lowered from the outer side Wo to the inner side Wi in the tire width direction, and the uneven wear of the portion near the ground contact end E can further effectively be suppressed.

In this embodiment, each of the small holes 54 has the circular cross-sectional shape. Thus, stress is not concentrated in a specified direction around each of the small holes 54 but is dispersed over the entire circumference of each of the small holes 54. Therefore, cracking of the small holes 54 can be prevented.

In this embodiment, the depth direction m of the recessed grooves 50 and the depth direction n of the small holes 54 are set such that the tilt angle θ thereof with respect to the perpendicular direction L to the tire equatorial plane CL is equal to or smaller than ±30°. Thus, when the tire that has been vulcanized and shaped is removed from a mold, projections that have been used to shape the recessed grooves 50 and the small holes 54 can easily be pulled out. Therefore, chipping around the recessed grooves 50 and the small holes 54 can be prevented when the tire is removed from the mold.

### Modified Embodiment

The above embodiment is merely provided as an example and thus has no intention of limiting the scope of the invention. This novel embodiment can be implemented in any of various other modes, and various types of elimination, replacement, and changes can be made thereto within the scope that does not depart from the gist of the invention.

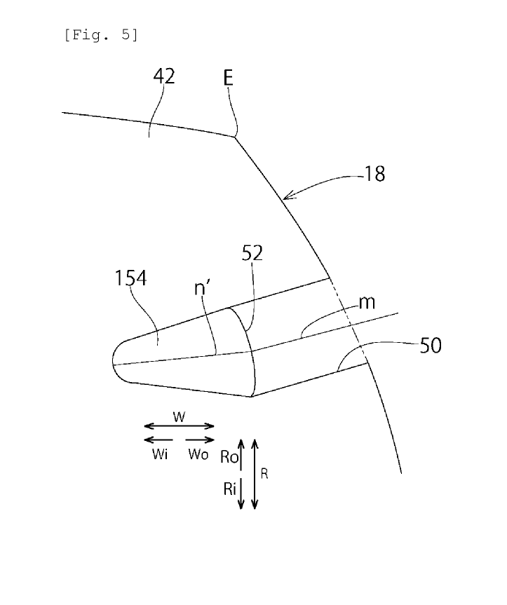

For example, as illustrated in FIG. 5, a depth direction n′ of each of the small holes 54 may be bent outward Ro in the tire radial direction with respect to the depth direction m of the recessed groove 50, and thereby the depth direction n′ of each of the small holes 54 may differ from the depth direction m of the recessed groove 50. Also, in this case, since the small holes 54 are bent outward Ro in the tire radial direction with respect to the recessed groove 50, a tilt angle of the depth direction n′ of each of the small holes 54 with respect to the perpendicular direction L to the tire equatorial plane CL becomes small. Thus, in addition to the above-described effects, when the tire, which has been vulcanized and shaped, is removed from the mold, chipping of the small holes 54, which are particularly likely to be chipped, can be suppressed.

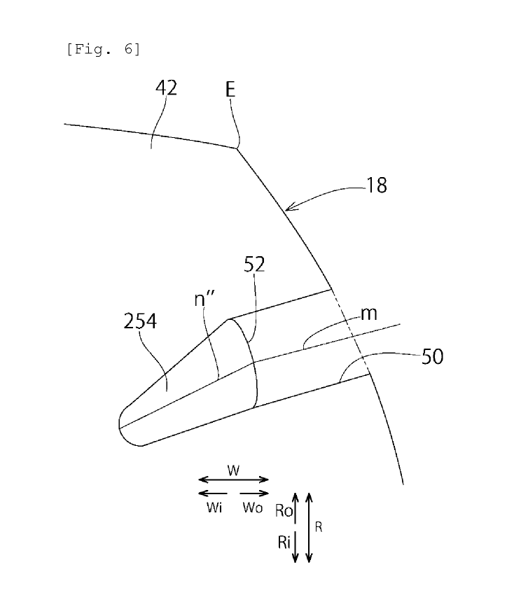

In addition, as illustrated in FIG. 6, a depth direction n′ of each of the small holes 54 may be bent inward Ri in the tire radial direction with respect to the depth direction m of the recessed groove 50, and thereby the depth direction n″ of each of the small holes 54 may differ from the depth direction m of the recessed groove 50. Also, in this case, since the small holes 54 are bent inward Ri in the tire radial direction with respect to the recessed groove 50, the small holes 54 can be arranged inward Ri in the tire radial direction from the recessed groove 50. Thus, in addition to the above-described effects, a ground contact pressure in the portion near each of the ground contact ends E can be equalized until the last stage of the tire wear.

What is claimed is:

1. A pneumatic tire comprising: a tread; a sidewall; a buttress portion provided between the tread and the sidewall; a recessed groove provided along a tire circumferential direction in the buttress portion; and plural small holes provided at spaced intervals along the tire circumferential direction in a groove bottom of the recessed groove.

2. The pneumatic tire according to claim 1, wherein
a cross-sectional area of each of the small holes is reduced toward a deep side in a depth direction.

3. The pneumatic tire according to claim 1, wherein
each of the small holes has a circular cross-sectional shape.

4. The pneumatic tire according to claim 1, wherein
a tilt angle of a depth direction of each of the small holes with respect to a perpendicular direction to a tire equatorial plane is equal to or smaller than ±30°.

5. The pneumatic tire according to claim 1, wherein
the groove bottom of the recessed groove has a perpendicular surface to a depth direction of the recessed groove.

6. The pneumatic tire according to claim 1, wherein
a depth direction of each of the small holes is parallel to a depth direction of the recessed groove.

7. The pneumatic tire according to claim 1, wherein
a depth direction of each of the small holes is bent outward in a tire radial direction with respect to a depth direction of the recessed groove.

8. The pneumatic tire according to claim 1, wherein
a depth direction of each of the small holes is bent inward in a tire radial direction with respect to a depth direction of the recessed groove.

9. The pneumatic tire according to claim 1, wherein
an interval between each adjacent pair of the small holes in the tire circumferential direction is equal to or longer than 200% of a diameter of each of the small holes and is equal to or shorter than 400% thereof.

10. The pneumatic tire according to claim 1, wherein
depth of each of the small holes is equal to or greater than 20% of depth of the recessed groove and is equal to or less than 100% thereof.
